(19) United States
(12) Patent Application Publication
(10) Pub. No.: US 2013/0065033 A1
(43) Pub. Date: Mar. 14, 2013

(54) Multilayer Polyimide-Containing Film and Manufacturing Method Thereof

(71) Applicants: Paul S. C. WU, Hsinchu County (TW); Chi-Huan Lo, Hsinchu County (TW); Ching-Wen Yu, Hsinchu County (TW); Chung-Yi Chen, Hsinchu County (TW); Sheng-Yu Huang, Hsinchu County (TW); Cheng-Han Chen WU, Hsinchu County (TW); Wen-Hsuan Chung, Hsinchu County (TW)

(72) Inventors: Paul S. C. WU, Hsinchu County (TW); Chi-Huan Lo, Hsinchu County (TW); Ching-Wen Yu, Hsinchu County (TW); Chung-Yi Chen, Hsinchu County (TW); Sheng-Yu Huang, Hsinchu County (TW); Cheng-Han Chen WU, Hsinchu County (TW); Wen-Hsuan Chung, Hsinchu County (TW)

(73) Assignee: TAIMIDE TECHNOLOGY INCORPORATED, Hsinchu Hsien (TW)

(21) Appl. No.: 13/538,083

(22) Filed: Jun. 29, 2012

(30) Foreign Application Priority Data
Sep. 9, 2011 (TW) 100132660
Apr. 27, 2012 (TW) 101115235

(51) Int. Cl. B32B 27/36; B32B 7/02

(52) U.S. Cl. 428/212; 428/336

(57) ABSTRACT

A multilayer polyimide-containing film comprises a coloring layer containing a pigment, and a first protection layer disposed on one surface of the coloring layer, the first protection layer having a thickness between about 0.5 and about 3 micrometers. In some embodiments, methods of manufacturing the multilayer polyimide-containing film are also described.

### CROSS-REFERENCE TO RELATED APPLICATIONS

This application claims priority of Taiwan application no. 100132660 filed on Sep. 9, 2011, and Taiwan application no. 101115235 filed on Apr. 27, 2012.

### STATEMENT REGARDING FEDERALLY SPONSORED RESEARCH

Not applicable.

### BACKGROUND OF THE INVENTION

1. Field of the Invention

The present inventions relate to multilayer polyimide-containing films and fabrication processes thereof.

2. Description of the Related Art

Printed circuit boards (“PCB”) have to be higher in density and efficiency, and lightweight, for applications such as mobile communication and portable electronic devices. In order to prevent oxidation of the metal lines printed on the PCB induced by contact with moisture, a protection film can cover and protect the PCB. For flexible circuit boards, polyimide film is widely used based on its advantageous mechanical strength, flexibility, solvent resistance, dielectric property and heat resistance. Generally, a polyimide film may be transparent with a yellowish color so that circuit patterns on the PCB can be visible even when covered by the polyimide film.

For applications in which it is desired to conceal the circuit design of the PCB from undesirable viewers and require specific color appearance, U.S. Pat. No. 5,031,017 and U.S. Pat. No. 5,078,936 disclose polyimide films with special color and shielding ability, the disclosure of which is incorporated herein by reference. One disadvantage of the proposed polyimide films is that the pigment contained in the film may flake off when the film undergoes a surface treatment such as plasma treatment, corona discharge treatment, sand blasting, solvent wipe and the like. This dispersion of the pigment may contaminate the processing equipments and alter the color of the film.

Therefore, there is a need for a polyimide film that can exhibit desirable color appearance, provide effective light shielding, and is resistant to surface treatment.

### BRIEF SUMMARY OF THE INVENTION

The present application provides a multilayer polyimide-containing film comprising a coloring layer containing a pigment, and a first protection layer disposed on a first surface of the coloring layer, the first protection layer having a thickness between about 0.5 and about 3 micrometers.

### BRIEF DESCRIPTION OF THE DRAWINGS

FIG. 1 is schematic view illustrating one embodiment of a multilayer polyimide-containing film; and

FIG. 2 is a schematic view illustrating another embodiment of a multilayer polyimide-containing film.

### DETAILED DESCRIPTION OF THE INVENTION

The present application describes multilayer polyimide-containing films which are resistant to surface treatment, exhibit desired colors, are opaque and impervious to light, and has desired electrical properties. In addition, certain embodiments of the multilayer polyimide-containing film can have low glossiness, resistance to surface treatment, desired color and electric properties.

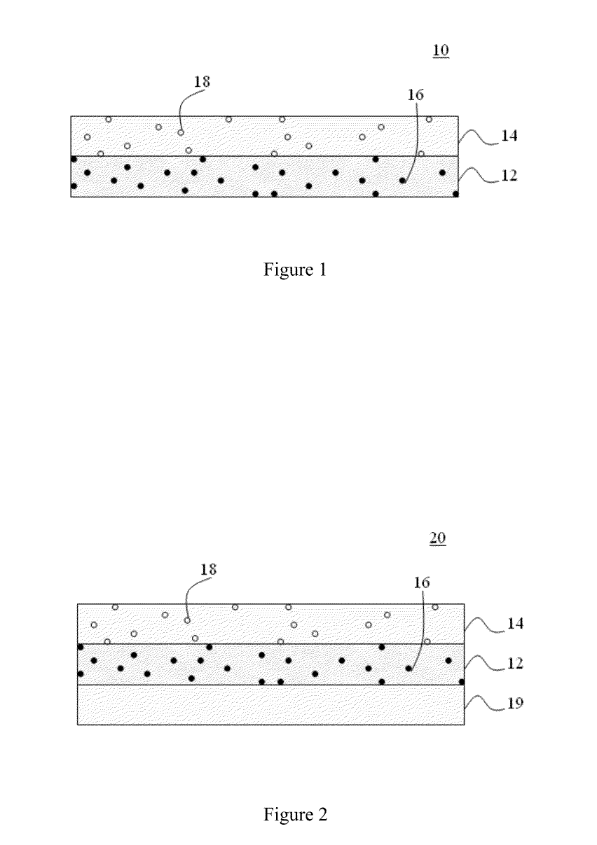

FIG. 1 is a schematic view illustrating one embodiment of a multilayer polyimide-containing film 10. The multilayer polyimide-containing film 10 can contain a coloring layer 12, and a first protection layer 14 disposed on an upper surface of the coloring layer 12. The coloring layer 12 can contain a pigment 16 selected for the multilayer polyimide-containing film 10 to exhibit a desired color.

The pigment 16 may be an organic pigment or an inorganic pigment. Examples of the pigment 16 can include, without limitation, Cadmium Red, Cadmium Vermilion, Alizarin Crimson, Permanent Magenta, Van Dyke brown, Barium Lemon Yellow, Cadmium Yellow Lemon, Cadmium Yellow Light, Cadmium Yellow Middle, Cadmium Yellow Orange, Scarlet Lake, Raw Umber Greenish, Burnt Umber, or black pigment such as carbon black, cobalt oxide, Fe—Mn—Bi black, Fe—Mn oxide spinel black, (Fe,Mn)₂O₃ black, copper chromite black spinel, lampblack, bone black, bone ash, bone char, hematite, iron oxide black, micaceous iron oxide, black complex inorganic color pigment (CICP), CuCr₂O₄ black, (Ni,Mn,Co)(Cr,Fe)₂O₄ black, aniline black, perylene black, anthraquinone black, chrome green black hematite, iron-chromium mixed oxides or any mixture thereof.

In some embodiments, the organic or inorganic pigment can also be selected from compounds classified in a color index (C.I.) (e.g., the color index published by The Society of Dyers and Colourists). For example, yellow pigments can include, C.I. pigment yellow 1, C.I. pigment yellow 3, C.I. pigment yellow 12, C.I. pigment yellow 13, C.I. pigment yellow 14, C.I. pigment yellow 15, C.I. pigment yellow 16, C.I. pigment yellow 17, C.I. pigment yellow 20, C.I. pigment yellow 24, C.I. pigment yellow 31, C.I. pigment yellow 53, C.I. pigment yellow 83, C.I. pigment yellow 86, C.I. pigment yellow 93, C.I. pigment yellow 94, C.I. pigment yellow 109, C.I. pigment yellow 110, C.I. pigment yellow 117, C.I. pigment yellow 125, C.I. pigment yellow 128, C.I. pigment yellow 137, C.I. pigment yellow 138, C.I. pigment yellow 139, C.I. pigment yellow 147, C.I. pigment yellow 148, C.I. pigment yellow 150, C.I. pigment yellow 153, C.I. pigment yellow 154, C.I. pigment yellow 166, C.I. pigment yellow 173, C.I. pigment yellow 194, C.I. pigment yellow 214 and the like.

Orange pigments can include, C.I. pigment orange 13, C.I. pigment orange 31, C.I. pigment orange 36, C.I. pigment orange 38, C.I. pigment orange 40, C.I. pigment orange 42, C.I. pigment orange 43, C.I. pigment orange 51, C.I. pigment orange 55, C.I. pigment orange 59, C.I. pigment orange 61, C.I. pigment orange 64, C.I. pigment orange 65, C.I. pigment orange 71, C.I. pigment orange 73 and the like.

Red pigments can include, C.I. pigment red 9, C.I. pigment red 97, C.I. pigment red 105, C.I. pigment red 122, C.I. pigment red 123, C.I. pigment red 144, C.I. pigment red 149, C.I. pigment red 166, C.I. pigment red 168, C.I. pigment red 176, C.I. pigment red 177, C.I. pigment red 180, C.I. pigment red 192, C.I. pigment red 209, C.I. pigment red 215, C.I. pigment red 216, C.I. pigment red 224, C.I. pigment red 242, C.I. pigment red 254, C.I. pigment red 264, C.I. pigment red 265 and the like.

Blue pigments can include, C.I. pigment blue 15, C.I. pigment blue 15:3, C.I. pigment blue 15:4, C.I. pigment blue 15:6, C.I. pigment blue 60 and the like.

Purple pigments can include, C.I. pigment purple 1, C.I. pigment purple 19, C.I. pigment purple 23, C.I. pigment purple 29, C.I. pigment purple 32, C.I. pigment purple 36, C.I. pigment purple 38 and the like.

Green pigments can include, C.I. pigment green 7, C.I. pigment green 36 and the like. Brown pigments can include C.I. pigment brown 23, C.I. pigment brown 25 and the like. Black pigments can include C.I. pigment black 1, C.I. pigment black 7 and the like.

The organic pigments and the inorganic pigments can be used independently or in combination.

If needed, one or more fillers can be added into the coloring layer 12 so that the multilayer polyimide-containing film 10 can have certain desired properties. Examples of the filler can include, e.g., a thermally conductive material, an electrically conductive material, a metal powder or sol-gel material. The thermally conductive material can include boron nitride (BN), titanium diboride (TiB₂) or aluminum oxide. The electrical-conductive material can include copper powder. A film incorporating an electrically conductive material can reduce or eliminate static electricity, and can be used as electric conductor. A film incorporating a metal powder (such as copper powder) can be used as a seeding layer for plating or electroless plating. Moreover, the addition of a sol-gel material in the film can increase its surface roughness and contact area, which can improve interlayer adhesion of the plated layers.

Referring again to FIG. 1, the first protection layer 14 can be disposed on the upper surface of the coloring layer 12 to prevent flaking and exposure of the pigment 16 when the coloring layer 12 undergoes a surface treatment. The surface treatment applied can include plasma treatment, corona discharge treatment, sand blasting, solvent wipe and the like. The dispersion of the pigment that may occur with the protection layer 14 may contaminate the processing equipments, and result in the multilayer polyimide-containing film 10 having non-uniform color, causing color alteration.

In some embodiments, the first protection layer 14 can be a polyimide material, in particular low-color polyimide. In other embodiments, the first protection layer 14 can be made by certain transparent plastic material, in particular plastic material with high light transmittance and low color. Examples of suitable plastic materials can include, polycarbonate (PC), polyethersulfone (PES), polyarylate (PAR), polynorbornene (PNB), polyethylene terephathalate (PET), polyetheretherketone (PEEK), polysulfone (PSF), polyethylenenaphthalate (PEN), polyetherimide (PEI) and the like, which can be used alone or in combination.

The first protection layer 14 can also prevent flaking of the pigment contained in the coloring layer 12 that may be induced by an exposure to a high-temperature or high-pressure environment occurring in certain processing steps, e.g., when the multilayer polyimide-containing film 10 is adhered or pressed against another material. The dispersion of the pigment that may occur when no protection layer is provided may contaminate the material or affect the mechanical and/or electrical properties of the entire film structure.

In order to reduce glossiness of the multilayer polyimide-containing film 10, a matting agent 18 can be optionally incorporated into the first protection layer 14. In some embodiments, the multilayer polyimide-containing film 10 can have a gloss between 3 and 63. The content of the matting agent 18 can be in a range between about 1 and about 15 wt % of the total weight of the first protection layer 14. Examples of the matting agent 18 can include, without limitation, a metal or non-metal oxide (such as silicon dioxide, aluminum oxide, zirconia and the like), a metal or non-metal sulfate (such as barium sulfate), a metal or non-metal nitride, a metal or non-metal boride, calcium carbonate, polyimide powder, or a mixture thereof. In embodiments where the matting agent is in a powder form, the average particle size of the matting agent can be between any two of the following sizes: 3, 3.5, 4, 4.5, 5, 5.5, 6, 6.5, 7, 7.5, 8, 8.5 and 9.0 microns.

The coloring layer 12 and the first protection layer 14 may be formed by continuous coating methods or discontinuous coating methods. A continuous coating method can include spin coating, slot-die coating, single-layer extrusion coating, dip coating, roll coating, spray coating, slide coating, curtain coating, gravure printing, multilayer co-extrusion coating and the like. The coloring layer 12 and the first protection layer 14 can be formed sequentially or simultaneously with a continuous coating method.

A discontinuous coating method can include inkjet printing, screen-printing and the like, which can form the coloring layer 12 and the first protection layer 14 as a plurality of layers successively coated on one another, or through a continuous processing.

FIG. 2 is a schematic view illustrating another embodiment of a multilayer polyimide-containing film 20. The multilayer polyimide-containing film 20 can include a coloring layer 12, a first protection layer 14 disposed at an upper surface of the coloring layer 12, and a second protection layer 19 disposed at a lower surface of the coloring layer 12 opposite to the side of the first protection layer 14.

In one embodiment, the second protection layer 19 can be formed from materials and compounds similar to those of the first protection layer 14. In other embodiments, the second protection layer 19 can also be a polymer film with or without matting agent.

Compared to the multilayer polyimide-containing film 10 shown in FIG. 1, the multilayer polyimide-containing film 20 has an additional second protection layer 19 at a lower surface of the coloring layer 12, such that the coloring layer 12 can be sandwiched between the first protection layer 14 and the second protection layer 19. With this configuration, the lower surface of the coloring layer 12 can be protected by the second protection layer 19, whereby the occurrence of flaking and exposure of the pigment 16 can be prevented, which can reduce or eliminate color alteration of the coloring layer 12. Moreover, flaking of the pigment from the upper and the lower sides of the coloring layer 12 can also be prevented in a high-temperature or high-pressure environment, such as when the multilayer polyimide-containing film 20 is adhered or pressed to another material.

Like previously described, the coloring layer 12, the first protection layer 14 and the second protection layer 19 can be formed sequentially by spin coating, slot-die coating, single-layer extrusion coating or the like. In alternate embodiments, these layers can also be formed a batch or continuous process in which multiple layer coated. The coloring layer 12, the first protection layer 14 and the second protection layer 19 can also be formed concurrently by multilayer co-extrusion coating.

The multilayer polyimide-containing film can find multiple applications in components of electronic devices such as flexible printed boards, rigid printed boards, flexible-rigid printed boards, liquid crystal displays, light-emitting diodes, photovoltaic cells, organic light-emitting diodes, portable communication devices, digital cameras, laptops, tablet computers and the like.

### EXAMPLES

### Preparation of a Slurry for the Protection Layer

About 160 kg of dimethylacetamide (DMAc) and about 19.1 kg (0.0955 kmole) of 4,4′-oxydianiline (4,4′-ODA) can be added, mixed and dissolved in a 200 L reactor. Then, about 20.8 kg (0.0954 kmole) of pyromellitic dianhydride (PMDA) can be added into the reactor and continuously stirred for about 3 hours. As a result, a polyimide slurry can be formed with a viscosity of about 200,000 cps.

Preparation of a Black Slurry

About 160 kg of DMAc and about 18.2 kg (0.091 kmole) of 4,4′-ODA can be added, mixed and dissolved in a 200 L reactor. Then about 2 kg of low conductive carbon black (EVONIK Special Black 4) and about 19.8 kg (0.0908 kmole) of PMDA can be added into the reactor and continuously stirred for about 3 hours. As a result, a black polyimide slurry can be formed with a viscosity of about 220,000 cps.

Preparation of a Red Slurry

About 160 kg of DMAc and about 16.3 kg (0.0815 kmole) of 4,4′-ODA can be added, mixed and dissolved in a 200 L reactor. Then about 4 kg of TiO₂, about 2 kg of red pigment (BASF 3911HD) and about 17.7 kg (0.0812 kmole) of PMDA can be added into the reactor and continuously stirred for about 3 hours. As a result, a red polyimide slurry can be formed with a viscosity of about 160,000 cps.

Preparation of Polyimide Powder (“PI Powder”)

About 570 g of DMAc used as solvent can be added into a three-necked flask. About 14.35 g of 4,4′-ODA and about 14.86 g of PMDA (which is about 5 wt % of total weight of the reaction solution, the molar ratio being about 1:0.950) can be incorporated and stirred with the solvent. After the reactants are completely dissolved, about 3.17 of 3-picoline can be incorporated into the mixture. The reaction can be conducted for about 18 hours under continuously agitation and heating to about 170 to produce a precipitate of polyimide. The precipitate of polyimide can be washed by water and ethanol, filtrated in vacuum, and baked at about 160° C. in a baking oven for about 1 hour. Then polyimide powder can be produced. The polyimide powder can be further ground and sieved so as to obtain particles with diameters between about 4 and about 10 micrometers.

### Example 1

A slurry of the protection layer and a black polyimide slurry as described previously can be used in a continuous process of three-layer co-extrusion coating to form a multilayer polyimide-containing film having a first protection layer, a second protection layer and a black layer sandwiched between the first and second protection layers. The thickness of the first protection layer can be about 0.5 micrometers, the thickness of the black layer can be about 11 micrometers, and the thickness of the second protection layer can be about 0.5 micrometers. The multilayer polyimide-containing film can be tested for its mechanical and electrical properties, and to evaluate its surface characteristics after undergoing a surface treatment such as ethanol wipe and plasma treatment.

### Example 2

A multilayer polyimide-containing film can be prepared and tested like in Example 1, except that the thickness of the first protection layer is about 1 micrometer, the thickness of the black layer is about 10 micrometers, and the thickness of the second protection layer is about 1 micrometer.

### Example 3

A multilayer polyimide-containing film can be prepared and tested like described in Example 1, except that the thickness of the first protection layer is about 3 micrometers, the thickness of the black layer is about 6 micrometers, and the thickness of the second protection layer is about 3 micrometers.

### Example 4

Slurries of the protection layer and red polyimide as described above can be used in a continuous process in which three layers can be coated by co-extrusion to form a multilayer polyimide-containing film having a first protection layer, a second protection layer and a red layer sandwiched between the first and second protection layers. The thickness of the first protection layer is about 0.5 micrometers, the thickness of the black layer is about 11 micrometers, and the thickness of the second protection layer is about 0.5 micrometers. The obtained multilayer polyimide-containing film can be tested for its mechanical and electrical properties, and its surface characteristics can be evaluated after the multilayer polyimide-containing film undergoes a surface treatment such as ethanol wipe and plasma treatment.

### Example 5

A multilayer polyimide-containing film can be prepared and tested like described in Example 4, except that the thickness of the first protection layer is about 1 micrometer, the thickness of the red layer is about 10 micrometers, and the thickness of the second protection layer is about 1 micrometer.

### Example 6

A multilayer polyimide-containing film can be prepared and tested as described in Example 4, except that the thickness of the first protection layer is about 3 micrometers, the thickness of the black layer is about 6 micrometers, and the thickness of the second protection layer is about 3 micrometers.

### Example 7

About 1 wt % of SiO₂ (Grace P403) can be added as a matting agent in the slurry of the protection layer. A multilayer polyimide-containing film can be prepared as described in Example 2, the thickness of the first protection layer being about 1 micrometer, the thickness of the black layer about 10 micrometers, and the thickness of the second protection layer about 1 micrometer. The obtained multilayer polyimide-containing film can be tested for its mechanical properties and gloss, and for the dispersion of the matting agent.

### Example 8

A multilayer polyimide-containing film can be prepared and tested as described in Example 7, except that the amount of the matting agent is about 2 wt %.

### Example 9

A multilayer polyimide-containing film can be prepared and tested as described in Example 7, except that the amount of the matting agent is about 5 wt %.

### Example 10

A multilayer polyimide-containing film can be prepared and tested as described in Example 7, except that the amount of the matting agent is about 13 wt %.

### Example 11

A multilayer polyimide-containing film can be prepared and tested as described in Example 7, except that the amount of the matting agent is about 20 wt %.

### Example 12

About 1 wt % of SiO₂ (Grace P403) can be added as a matting agent in the slurry of the protection layer. A multilayer polyimide-containing film can be prepared as described in Example 5, the thickness of the first protection layer being about 1 micrometer, the thickness of the red layer about 10 micrometers, and the thickness of the second protection layer about 1 micrometer. The obtained multilayer polyimide-containing film can be tested for its mechanical properties and gloss, and the dispersion of the matting agent.

### Example 13

A multilayer polyimide-containing film can be prepared and tested as described in Example 12 except that the amount of the matting agent is about 2 wt %.

### Example 14

A multilayer polyimide-containing film can be prepared and tested as described in Example 12 except that the amount of the matting agent is about 5 wt %.

### Example 15

A multilayer polyimide-containing film can be prepared and tested as described in Example 12 except that the amount of the matting agent is about 13 wt %.

### Example 16

A multilayer polyimide-containing film can be prepared and tested as described in Example 12 except that the amount of the matting agent is about 20 wt %.

### Example 17

About 1 wt % of the polyimide powder can be added as a matting agent in the slurry of the protection layer. A multilayer polyimide-containing film can be prepared as described in Example 2, the thickness of the first protection layer being about 1 micrometer, the thickness of the black layer about 10 micrometers, and the thickness of the second protection layer about 1 micrometer. The obtained multilayer polyimide-containing film can be tested for its mechanical properties and gloss, and the dispersion of the matting agent.

### Example 18

A multilayer polyimide-containing film can be prepared and tested as described in Example 17, except that the amount of the matting agent is about 2 wt %.

### Example 19

A multilayer polyimide-containing film can be prepared and tested as described in Example 17 except that the amount of the matting agent is about 5 wt %.

### Example 20

A multilayer polyimide-containing film can be prepared and tested as described in Example 17 except that the amount of the matting agent is about 13 wt %.

### Example 21

A multilayer polyimide-containing film can be prepared and tested as described in Example 17 except that the amount of the matting agent is about 20 wt %.

### Example 22

About 1 wt % of the polyimide powder can be added as a matting agent in the slurry of the protection layer. A multilayer polyimide-containing film can be prepared as described in Example 5, the thickness of the first protection layer being about 1 micrometer, the thickness of the red layer about 10 micrometers, and the thickness of the second protection layer about 1 micrometer. The obtained multilayer polyimide-containing film can be tested for its mechanical properties and gloss, and the dispersion of the matting agent.

### Example 23

A multilayer polyimide-containing film can be prepared and tested as described in Example 22 except that the amount of the matting agent is about 2 wt %.

### Example 24

A multilayer polyimide-containing film can be prepared and tested as described in Example 22 except that the amount of the matting agent is about 5 wt %.

### Example 25

A multilayer polyimide-containing film can be prepared and tested as described in Example 22 except that the amount of the matting agent is about 13 wt %.

### Example 26

A multilayer polyimide-containing film can be prepared and tested as described in Example 22 except that the amount of the matting agent is about 20 wt %.

### Comparative Example 1

The black polyimide slurry can be used in a continuous process in which a single layer is coated to form a film with a thickness of about 12 micrometers.

### Comparative Example 2

The red polyimide slurry can be used in a continuous process in which a single layer is coated to form a film with a thickness of about 12 micrometers.

### Comparative Example 3

Slurries of the protection layer and black polyimide as described above can be used in a continuous process in which three layers can be coated by co-extrusion to form a multilayer polyimide-containing film having a first protection layer, a second protection layer and a black layer sandwiched between the first and second protection layers. The thickness of the first protection layer is about 0.2 micrometers, the thickness of the black layer is about 11.6 micrometers, and the thickness of the second protection layer is about 0.2 micrometers. The obtained multilayer polyimide-containing film can be tested for its mechanical and electrical properties, and its surface characteristics can be evaluated after the multilayer polyimide-containing film undergoes a surface treatment such as ethanol wipe and plasma treatment.

### Comparative Example 4

Slurries of the protection layer and red polyimide as described above can be used in a continuous process in which three layers are coated by co-extrusion to form a multilayer polyimide-containing film having a first protection layer, a second protection layer and a red layer sandwiched between the first and second protection layers. The thickness of the first protection layer is about 0.2 micrometers, the thickness of the red layer is about 11.6 micrometers, and the thickness of the second protection layer is about 0.2 micrometers. The obtained multilayer polyimide-containing film can be tested for its mechanical and electrical properties, and to evaluate its surface characteristics after the multilayer polyimide-containing film undergoes a surface treatment such as ethanol wiping and plasma treatment.

Tables 1-6 show examples of testing results applied for different films. In one embodiment, resistance of the film to de-coloration can be tested by wiping the film several times (e.g., 5 times) with a towel moistened with ethanol, and then determining the degree of de-coloration of the film by observing the amount of coloring agent that stain the towel. In another embodiment, resistance to de-coloration induced by plasma erosion can be tested by applying a surface treatment on a film (the surface area of the tested film may be about 10 cm×10 cm) in a plasma-processing equipment NEMST-D2002 (Nano Electronics and Micro System Technologies, Inc.) for about 20 minutes, with power about 15 KW, N₂ gas flow rate about 666 sccm, O₂ gas flow rate about 2000 sccm, and CF₄ gas flow rate about 666 sccm. The plasma-treated film then can wiped five times with a towel, which may be dry or impregnated with water or ethanol. Likewise, the degree of de-coloration of the polyimide film can be evaluated by observing the amount of coloring agent that stain the towel. In Tables 1-6, the results of these de-coloration testing methods are represented in the columns “Ethanol wiping” and “Resistance to plasma erosion”, in which symbol “N” means no de-coloration, symbol “S” means slight de-coloration, and symbol “L” means significant de-coloration.

The elongation rate can be tested by using Hounsfield Test Equipment H10K-S according to ASTM D-882 and IPC-TM-650 2.4.19. Gloss can be tested by using NIIPON Denshoku PG-1M Equipment, the angle of detection being 60°. The dielectric strength (Dk) can be tested by using Agilent 4294A (clip type 16034G) according to ASTM D150-95. Surface resistance (Rs) and volume resistance (Rv) can be tested by using Agilent 4339B testing equipment according to ASTM D257.

Dispersion of the matting agent can be analyzed by SEM. The testing results shown in Tables 3-6 can read as follows: symbol “ ” means that the average aggregate particle diameter of the matting agent is less than 8 micrometers, symbol “∘” means that the average aggregate particle diameter of the matting agent is less than micrometers, symbol “ ” means that the average aggregate particle diameter of the matting agent is less than 15 micrometers, and symbol “X” means that the average aggregate particle diameter of the matting agent is larger than 15 micrometers.

TABLE 1
Multilayer polyimide-containing film (black) with various
thicknesses of the protection layer:

| | Thick- | | | | | |
|---|---|---|---|---|---|---|
| | ness | | | | | |
| | of the | | | | | |
| | pro- | | Resis- | | | |
| | tection | Eth- | tance | Di- | Surface | Volume |
| | layer | anol | to | electric | resistance | resistance |
| | (micro- | wip- | plasma | strength | (Rs) | (Rv) |
| | meter) | ing | erosion | (Dk) | (Ω) | (Ω -cm) |
| Example 1 | 0.5 | S | S | 4.62 | 2.07E+16 | 1.16E+16 |
| Example 2 | 1 | N | N | 4.57 | 3.14E+16 | 2.26E+16 |
| Example 3 | 3 | N | N | 4.48 | 1.02E+17 | 1.97E+17 |
| Comparative | 0 | L | L | 4.66 | 6.72E+13 | 4.12E+13 |
| Example 1 | | | | | | |
| Comparative | 0.2 | S | L | 4.65 | 3.12E+15 | 3.95E+15 |
| Example 3 | | | | | | |

As shown in Table 1, the black polyimide film without protection layer in Comparative Example 1 exhibits significant de-coloration (i.e., color alteration) after it undergoes ethanol wipe or plasma treatment, and has a surface resistance (Rs) and a volume resistance (Rv) much lower than those of a multilayer polyimide-containing film with a protection layer. Moreover, when the protection layer is too thin (e.g., Comparative Example 3 is less than 0.5 micrometers), the black polyimide film may also exhibit significant de-coloration, lower Rs and lower Rv. However, the black multilayer polyimide-containing film having the protection layer(s) with a thickness of about 0.5-3 micrometers is resistant to surface treatment such as ethanol wiping or plasma treatment, and is a good insulant with enhanced Rs and Rv.

TABLE 2
Multilayer polyimide-containing film (red) with various
thicknesses of the protection layer:

| | Thick- | | | | | |
|---|---|---|---|---|---|---|
| | ness | | | | | |
| | of the | | | | | |
| | pro- | | Resis- | | | |
| | tection | Eth- | tance | Di- | Surface | Volume |
| | layer | anol | to | electric | resistance | resistance |
| | (micro- | wip- | plasma | strength | (Rs) | (Rv) |
| | meter) | ing | erosion | (Dk) | (Ω) | (Ω -cm) |
| Example 4 | 0.5 | S | S | 4.08 | 1.68E+16 | 2.98E+16 |
| Example 5 | 1 | N | N | 3.97 | 2.75E+16 | 2.41E+16 |
| Example 6 | 3 | N | N | 3.86 | 1.98E+17 | 2.09E+17 |
| Comparative | 0 | L | L | 4.15 | 2.11E+16 | 2.71E+16 |
| Example 2 | | | | | | |
| Comparative | 0.2 | S | L | 4.12 | 2.01E+16 | 2.83E+16 |
| Example 4 | | | | | | |

As shown in Table 2, the red polyimide film without protection layer in Comparative Example 2 has significant de-coloration after undergoing ethanol wiping or plasma treatment. When the protection layer is too thin (e.g., Comparative Example 4 less than 0.5 micrometers), the red polyimide film also has significant de-coloration. However, the red multilayer polyimide-containing film having the protection layer(s) with a thickness of about 0.5-3 micrometers can effectively prevent powder from flaking and color alteration.

TABLE 3
Multilayer polyimide-containing film (black) with silicon
dioxide as the matting agent:

| | Amount of | | | Elongation |
|---|---|---|---|---|
| | the silicon | | Dispersion of the | rate |
| | dioxide (wt %) | Gloss | matting agent | (%) |
| Example 2 | 0% | 92 | — | 62 |
| Example 7 | 1% | 63 | | 61 |
| Example 8 | 2% | 38 | | 59 |
| Example 9 | 5% | 8 | ∘ | 57 |
| Example 10 | 13% | 2 | | 53 |
| Example 11 | 20% | — | x | 48 |
| Comparative | 0 | 95 | — | 60 |
| Example 1 | | | | |

TABLE 4
Multilayer polyimide film (red) with silicon dioxide as the
matting agent:

| | Amount of | | | Elongation |
|---|---|---|---|---|
| | the silicon | | Dispersion of the | rate |
| | dioxide (wt %) | Gloss | matting agent | (%) |
| Example 5 | 0% | 95 | — | 48 |
| Example 12 | 1% | 66 | | 46 |
| Example 13 | 2% | 44 | | 44 |
| Example 14 | 5% | 13 | ∘ | 41 |
| Example 15 | 13% | 5 | | 36 |
| Example 16 | 20% | — | x | 33 |
| Comparative | 0 | 96 | — | 46 |
| Example 2 | | | | |

As shown in Tables 3 and 4, the multilayer polyimide-containing film without matting agent has a high gloss value, which is similar to that of the comparative examples. In the other instances, the gloss can be reduced by adding the matting agent into the multilayer polyimide-containing film.

Because the matting agent has a poor dispersion in the protection layer, the gloss value cannot be accurately tested in instances in which the matting agent made of silicon dioxide reach 20 wt %. The high content of the matting agent is unfavorable to process performance.

In instances where the protection layer contains about 1-13 wt % of silicon dioxide as matting agent, the multilayer polyimide-containing film can exhibit a good elongation rate (the black film can reach 50% or above), as well as low gloss and excellent light dispersion from the matting agent.

TABLE 5
Multilayer polyimide-containing film (black) with PI powder as
the matting agent:

| | | | | Elongation |
|---|---|---|---|---|
| | Amount of the PI | | Dispersion of the | rate |
| | powder (wt %) | Gloss | matting agent | (%) |
| Example 2 | 0% | 92 | — | 62 |
| Example 17 | 1% | 66 | | 60 |
| Example 18 | 2% | 47 | | 59 |
| Example 19 | 5% | 33 | ∘ | 56 |
| Example 20 | 13% | 10 | | 52 |
| Example 21 | 20% | — | x | 49 |
| Comparative | 0 | 95 | — | 60 |
| Example 1 | | | | |

TABLE 6
Multilayer polyimide-containing film (red) with PI powder as
the matting agent:

| | | | | Elongation |
|---|---|---|---|---|
| | Amount of the PI | | Dispersion of the | rate |
| | powder (wt %) | Gloss | matting agent | (%) |
| Example 5 | 0% | 95 | — | 48 |
| Example 22 | 1% | 68 | | 44 |
| Example 23 | 2% | 48 | | 42 |
| Example 24 | 5% | 35 | ∘ | 40 |
| Example 25 | 13% | 12 | | 34 |
| Example 26 | 20% | — | x | 32 |
| Comparative | 0 | 96 | — | 46 |
| Example 2 | | | | |

As shown in Tables 5 and 6, the multilayer polyimide-containing film without matting agent has a high gloss value, which is similar to that of the comparative examples. With the addition of the matting agent into the protection layer(s), the multilayer polyimide-containing film can exhibit a gloss value that can be significantly reduced.

Because the matting agent has a poor dispersion in the protection layer, the gloss value cannot be accurately tested in instances in which the matting agent made of polyimide powder reach 20 wt %. In instances where the protection layer contains about 1-13 wt % of polyimide powder as matting agent, the multilayer polyimide-containing film can exhibit a higher elongation rate (the black film can reach 50% or above), as well as low gloss and excellent light dispersion from the matting agent.

Accordingly, a multilayer polyimide-containing film provided with one or more protection layer as described herein can effectively prevent the pigment from flaking off during surface treatment or external force treatment. Problems such as contamination of equipments due to pigment dispersion, and color alteration of the film can be prevented. In addition, the gloss of the color multilayer polyimide-containing film can be reduced by adding an appropriate amount of a matting agent, so that the polyimide-containing film can exhibit desirable shielding effects, color, and mechanical properties (e.g., elongation rate).

The foregoing realizations have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope as defined in the claims that follow.

What is claimed is:

1. A multilayer polyimide-containing film comprising:
a coloring layer comprising a pigment and a polyimide, and
a first protection layer disposed on one surface of the coloring layer and having a thickness between about 0.5 and about 3 micrometers.

2. The multilayer polyimide-containing film of claim 1, wherein the first protection layer comprises a matting agent.

3. The multilayer polyimide-containing film of claim 2, wherein the matting agent has a mean particle size from about 3 to about 9 micrometers.

4. The multilayer polyimide-containing film of claim 2, wherein the matting agent has a total weight ratio with respect to the protection layer that is between about 1 and about 15 wt %.

5. The multilayer polyimide-containing film of claim 2, wherein the matting agent is selected from a group consisting of silicon dioxide, aluminum oxide, zirconia, barium sulfate, nitride, boride, calcium carbonate and polyimide powder.

6. The multilayer polyimide-containing film of claim 1, wherein the first protection layer is composed of a polyimide.

7. The multilayer polyimide-containing film of claim 1, wherein the first protection layer is a transparent plastic material selected from a group consisting of polycarbonate, polyethersulfone, polyarylate, polynorbornene, polyethylene terephathalate, polyetheretherketone, polysulfone, polyethylenenaphthalate and polyetherimide.

8. The multilayer polyimide-containing film of claim 1, further comprising a second protection layer disposed on a second surface of the coloring layer opposite to the side of the first protection layer.

9. The multilayer polyimide-containing film of claim 8, wherein the second protection layer comprises a matting agent.

10. The multilayer polyimide-containing film of claim 9, wherein the matting agent has a total weight ratio with respect to the second protection layer that is between about 1 and about 15 wt %.

11. The multilayer polyimide-containing film of claim 9, wherein the matting agent is selected from a group consisting of silicon dioxide, aluminum oxide, zirconia, barium sulfate, nitride, boride, calcium carbonate and polyimide powder.

12. The multilayer polyimide-containing film of claim 8, wherein the second protection layer is composed of a polyimide.
